(19) United States
(12) Patent Application Publication
(10) Pub. No.: US 2006/0269079 A1
(43) Pub. Date: Nov. 30, 2006

(54) Personal Electronic Audio Device with Flexible Supporting Conduit Structure

(76) Inventors: Han-Shin Hsia, Taipei City (TW); Fan-Hsu Franz Chien, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/383,223

(22) Filed: May 15, 2006

Related U.S. Application Data
(60) Provisional application No. 60/595,011, filed on May 27, 2005.

(51) Int. Cl. H04R 1/10

(52) U.S. Cl. 381/74

(57) ABSTRACT

A personal electronic audio device includes a supporting conduit structure/soft structure for housing audio wires wherein the supporting conduit structure/soft structure has a pouch/soft pocket; a first audio device for generating an audio signal; and a second audio device for receiving the audio signal and emitting a sound corresponding to the audio signal.

### CROSS REFERENCE TO RELATED APPLICATIONS

This application claims the priority benefit of provisional patent application No. 60/595,011 that was filed on May 27, 2005 and is included herein by reference.

### BACKGROUND OF THE INVENTION

1. Field of the Invention

The present invention relates to a personal electronic audio device, and more specifically, to a personal electronic audio device with a flexible supporting conduit structure/soft structure.

2. Description of the Prior Art

Varieties of portable electronic devices have been developed in response to consumer demand. Often consumers desire increased mobility and improved convenience. In response to the ever-growing demand, familiar electronic devices have been miniaturized for the consumer. Unfortunately, this small and lightweight size coupled with battery life spans that continue to increase offers their users as many conveniences as new problems to be solved. These devices are easily lost, misplaced, or stolen. Additionally, these devices are easily broken by being sat on, stepped on, or otherwise crushed. The same features that make a tiny and lightweight consumer electronic device very convenient for the user also make it susceptible to the slightest carelessness.

Radios and compact disc (CD) players are two good examples of consumer electronic devices that were once larger and heavier. These devices are now available in very tiny sizes. These small sizes allow their users to carry them easily. As a result, people are now able to utilize these devices in the traditional setting and in new exciting ways, for example, listening to music while running, biking, walking, trimming a hedge, mowing a lawn, cleaning, and many others activities.

Traditionally, prior art inventions have sought to mediate this situation by providing holding containers, protective cases, and other enclosures in which the device is placed. The intention is to provide a safe housing for the device yet maintain much of the portability and lightweight features. While offering some convenience to the user and some protection to the device, conventional devices allow the wires and cabling of the devices to be exposed. These exposed wires are susceptible to tangling, damage, and being caught on other objects resulting in damage to the device. Conventional inventions have tended to offer good protection for the device at the cost of limited access to the device's controls. Conventional prior art tends to be rigid in its shape. This does not permit the enclosure to satisfy the user's need for adaptability (i.e., flexibility and pliability) that would make a single holding enclosure capable accommodating the users current activities, such as: lying down resting, biking, skiing, reading, or using a computer at a desk.

It would be advantageous to provide a personal audio device that can accept a portable consumer electronic device and offer to that device a safe enclosure yet allow easy and full access of its controls, interface, buttons, and switches to the user. Further providing protective cover for audio wires (cables) increases safety to user, reduces opportunities for theft of the device. Being compatible with current audio standards would be highly desirable for the consumer. Finally, it would be advantageous for the personal audio device to offer a flexible design to provide the user with a robust range of adjustable positions and shapes based on the current desire.

The prior art is not able to provide the most efficient and effective means for utilizing the above-mentioned devices.

### SUMMARY OF THE INVENTION

It is therefore an objective of the claimed invention to provide a personal electronic audio device with a flexible supporting conduit structure/soft structure, to solve the above-mentioned problems.

According to the claimed invention, a personal electronic audio device is disclosed. The personal electronic audio device comprises: a supporting conduit structure/soft structure for housing audio wires wherein the supporting conduit structure/soft structure comprises a pouch/soft pocket coupled thereon; a first audio device, disposed in the pouch/soft pocket and coupled to the audio wires, for generating an audio signal; and a second audio device, coupled to the audio wires, for receiving the audio signal and emitting a sound corresponding to the audio signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a personal electronic audio device according to a first embodiment of the present invention.

FIG. 2 is a diagram of a personal electronic audio device according to a second embodiment of the present invention.

FIG. 3 is a diagram of a personal electronic audio device in an alternate configuration according to the second embodiment of the present invention.

FIG. 4 is a diagram of a personal electronic audio device according to a first embodiment of the present invention.

FIG. 5 is a diagram of a personal electronic audio device according to a first embodiment of the present invention.

FIG. 6 is a diagram of a personal electronic audio device according to a third embodiment of the present invention.

FIG. 7 is a diagram of a personal electronic audio device according to a fourth embodiment of the present invention.

FIG. 8 is a diagram of a personal electronic audio device according to a second embodiment of the present invention.

FIG. 9 is a diagram of a personal electronic audio device according to a first embodiment of the present invention.

### DETAILED DESCRIPTION

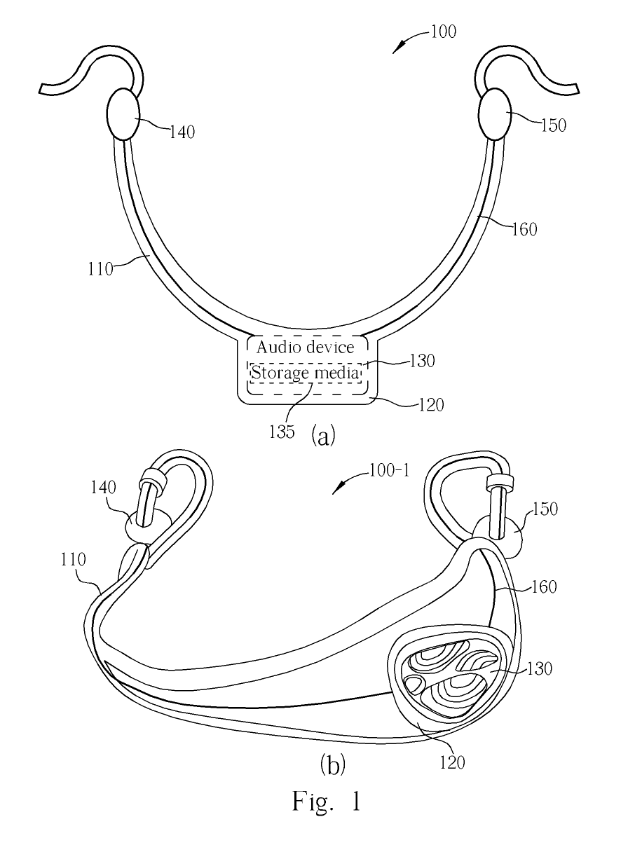

Please refer to FIG. 1a and FIG. 1b. FIG. 1a and 1b are diagrams of a personal electronic audio device 100 and personal electronic audio device 100-1, respectively, according to a first embodiment of the present invention. The supporting conduit structure/soft structure 110 is utilized for housing the audio wires 160. The supporting conduit structure/soft structure 110 provides protection via enclosure for the audio wires 160 keeping them free from becoming damaged, entangled, or otherwise harming said device's user as might happen with freely dangling loose cabling. In this embodiment of the present invention, the supporting conduit structure/soft structure 110 is made from a flexible material called neoprene. This gives the personal electronic audio device 100, 100-1, a rugged construction that is very suitable for utilizing the personal electronic audio device 100, 100-1, while exercising, performing household chores, traveling, or otherwise being in motion in any other way, however, the personal electronic audio device 100, 100-1, maintains lightweight and flexible properties that continue to make it useful to the user who is in motion or at rest. Other flexible materials like leather, chloroprene rubber, various textiles, rubber, and so on can be used for the construction of the supporting conduit structure/soft structure 110. Further, in this embodiment, the present invention supporting conduit structure/soft structure 110 is in the shape of a horseshoe as shown in FIG. 1a and is of an asymmetric triangle shape as shown in FIG. 1b. Please note that the supporting conduit structure/soft structure 110 is manufactured from any number of malleable and flexible materials that allow its user to easily reform it into any number of various shapes. For illustrative purposes, in this example, the supporting conduit structure/soft structure 110 takes the form of a horseshoe and an asymmetric triangle shape. Other possible shapes are presented in subsequent embodiments.

Additionally, the supporting conduit structure/soft structure 110 is coupled to a pouch/soft pocket 120. The pouch/soft pocket 120 is for holding (i.e., safeguarding) an audio device 130 positioned therein. It is also at the location of the pouch/soft pocket 120 where the audio device 130 is coupled to the audio wires 160. The pouch/soft pocket 120 is made from the same flexible material called Neoprene chloroprene rubber, various textiles, rubber, leather and so on, as is the supporting conduit structure/soft structure 110. Because the audio wires 160 are disposed within the flexible conduit structure/soft structure 110, the audio wires 160 are well protected from damage. In addition, the protective flexible conduit structure/soft structure 110 ensures that the audio wires 160 do not become entangled thus causing great inconvenience for the user to detangle.

The audio device 130 generates an audio signal (e.g., music) that is transmitted to a second audio device 140 by utilizing the audio cabling 160. The audio device 140 utilizes wires and cabling that are compatible with the stereo mini jack standard that is very popular among consumer electronic devices. Additionally, more audio devices such as an audio device 150 as shown in FIG. 1a and 1b of the first embodiment of the present invention can be utilized. Any additional audio devices, such as audio device 150, utilize the stereo mini jack wires and cabling specification to help provide maximum compatibility with the existing consumer electronic audio devices on the market. Audio devices include, but are not limited to, microphones and speakers.

The mini stereo jack that is displaced on the audio device 130 can be utilized for many functions. One function of the mini stereo jack is for transmitting data to or from the audio device 130. For example, utilizing an adaptor cable the mini stereo jack of the audio device 130 can be attached via universal serial bus (USB) cabling to other devices. Continuing with this example, the other device can be a personal computer having USB ports. Utilizing a combination of USB cables and USB-mini stereo jack adaptors, the audio device 130 is able to transmit data by way of its mini stereo jack. A second function of the mini stereo jack is for charging the battery that is located within the audio device 130. For example, here the mini stereo jack is for providing a conducting current to the audio device 130 for charging the battery (not shown) located inside the audio device 130.

In the first embodiment of the present invention, the audio device 130 contains a storage media 135, while audio devices 140 and 150 do not contain a storage media. The storage media 135 is a semiconductor storage device (e.g., a FLASH memory), a magnetic storage device (e.g., a magnetic disk), or an optical storage device (e.g., an optical disc). In this embodiment, the Flash-memory storage media is implemented because it is small, fast, and lightweight. These attributes provide a perfect match for the typical user's expectations of the audio device 130. Since the audio device 130 is placed into the flexible pouch/soft pocket 120, the audio device 130 is provided with a certain amount of shock protection (e.g., bumping, dropping, and jostling around) because the pouch/soft pocket 120 is made from a flexible material, in this case Neoprene chloroprene rubber, or various textiles, but additional materials that offer flexibility similar to neoprene or rubber will offer shock protection just as effectively. In this embodiment, the audio device 130 having the storage media 135 is a Flash-memory-based MP3 player.

In this embodiment of the present invention, the audio device 130 emits a sound corresponding to an audio signal that is transmitted to the audio devices 140 and 150 utilizing the audio wires 160. The audio signal generated by the audio device 130 is a two channel audio signal with the first channel audio being transmitted to audio device 140 and the second channel audio being transmitted to audio device 150. The user can then hear (i.e., listen to) the audio signal because audio devices 140 and 150 are miniature speakers called earphones that are placed in or very near to the user's ears. Please note that the audio device 130 also can be implemented by a cellular phone device as well as many other communication electronic devices. These examples are intended to provide further illustration of the present invention and are not limitations of the design of the present invention. Continuing with the example of the cellular phone, the user can control the cellular phone using voice commands. The voice commands, spoken by the user, are detected by the second audio device 140 or the third audio device 150 or both. In this example, the audio devices 140, or 150 are microphones. Audio devices 140 or 150 (e.g.,microphones) convert a sound into an audio signal that is then transmitted to the audio device 130 by utilizing the transmission path provided by the audio wires 160. Please note that for simplicity the storage media 135, shown in FIG. 1a is not shown in FIG. 1b.

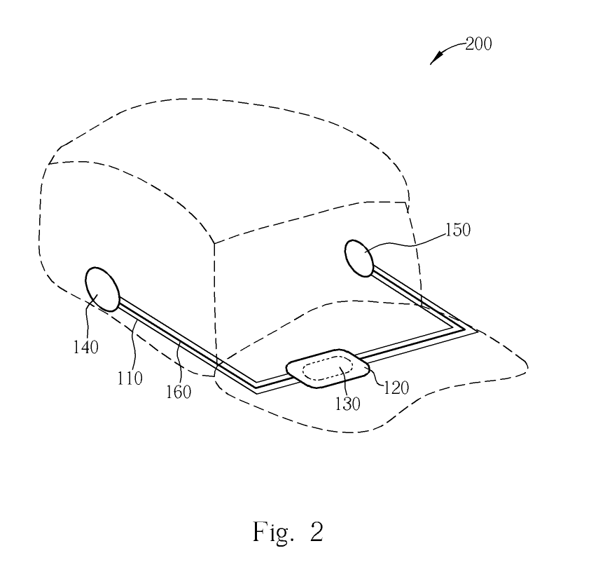

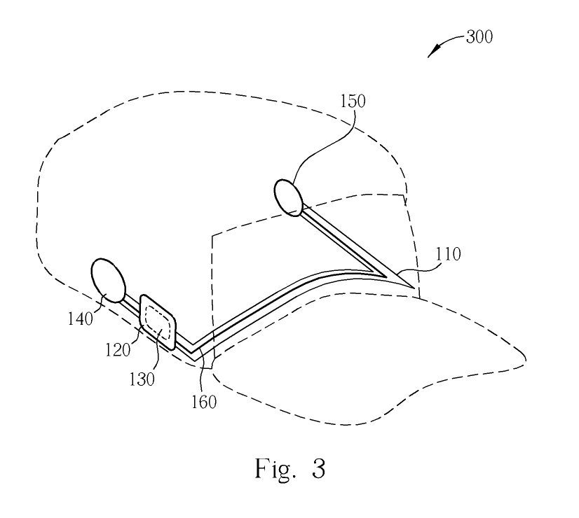

Please refer to FIG. 2. FIG. 2 is a diagram of a personal electronic audio device 200 according to a second embodiment of the present invention. In the second embodiment, the personal audio device 200 is integrated with a cap (e.g., a ball cap, or a hat). The functions of the various parts of the personal audio device 200 are identical to those of the first embodiment so repeated details are omitted for brevity. Please note that the flexible nature of the supporting conduit structure/soft structure 110 allows its user to customize its exact shape to suit the desired effect. In this example, the pouch/soft pocket 120 and the audio device 130 are displaced on the upper side brim of the cap as shown in FIG. 2, however, the pouch/soft pocket 120 and the audio device 130 can be relocated to any number of other positions, such as toward the inside top, inside back, or outside back of the cap. Please note that for simplicity the storage media 135, shown in FIG. 1a is not shown in FIG. 2. Please refer to FIG. 3. FIG. 3 is an alternate configuration of the second embodiment. In FIG. 3, the personal audio device 300 is shown with the pouch/soft pocket 120 and the audio device 130 in a second location disposed on an outer side of the cap. Please note that for simplicity the storage media 135, shown in FIG. 1a is not shown in FIG. 3.

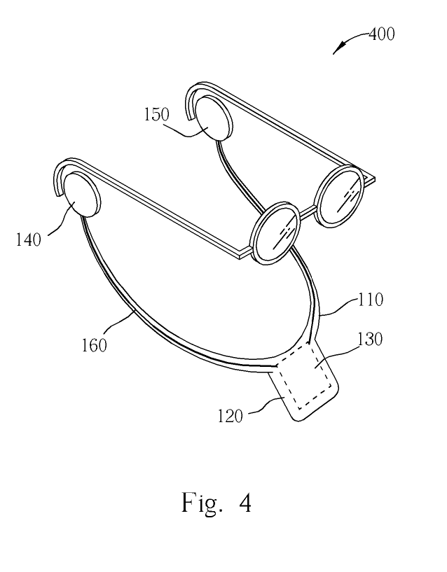

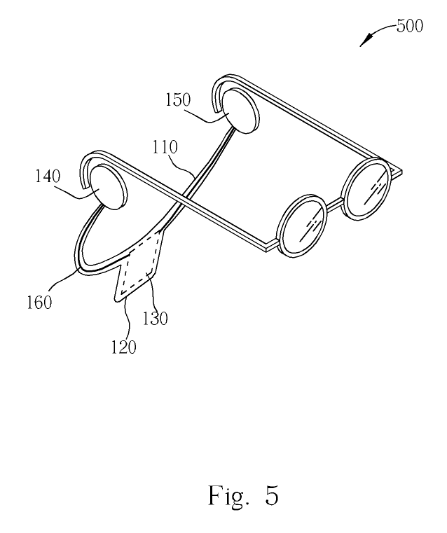

Please refer to FIG. 4. FIG. 4 is a diagram of a personal electronic audio device 400 according to a first embodiment of the present invention. In the first embodiment, the personal audio device 400 is integrated with a pair of glasses (e.g., a pair of sunglasses, reading glasses, or a protective eyewear). The functions of the various parts of the personal audio device 400 are identical to those of the first and second embodiments so repeated details are omitted for brevity. In this embodiment of the present invention, the personal audio device 400 appears to hang from the user's ears similar to an eyewear retainer or how an ID card will hang from a lanyard when the lanyard is displaced over the user's head and atop their shoulders. The personal audio device 400 is connected to the glasses utilizing any number of means for connecting the hook end of the glasses arm (the glasses part that partially encircles their wear's ear) and the audio devices 140, 150. For example, audio devices 140, 150 can utilize a snug fitting groove in which the glasses arms are disposed and snapped into to provide a firm connection. Additionally, the personal audio device 400 can be configured so that the pouch/soft pocket 120 and the audio device 130 are not lying on the user's chest region below their head (shown in FIG. 4) but rather such that the pouch/soft pocket 120 and the audio device 130 are lying on the user's back area (not shown in FIG. 4). It is also possible to wear the personal audio device 400 in front or back when needed for accessing the audio device 130 and then rotate the personal audio device 400 such that the point of rotation is where the glasses arms snap into the grooves on audio devices 140, 150 so as to wear the personal audio device 300 in the back of the user's head when desired. Please note that for simplicity the storage media 135, shown in FIG. 1a is not shown in FIG. 4. Please refer to FIG. 5. FIG. 5 is an alternate configuration of the third embodiment. In FIG. 5 the personal electronic audio device 500 is shown with the pouch/soft pocket 120 and the audio device 130 in a second location resting on the user's back. Please note that for simplicity the storage media 135, shown in FIG. 1a is not shown in FIG. 5.

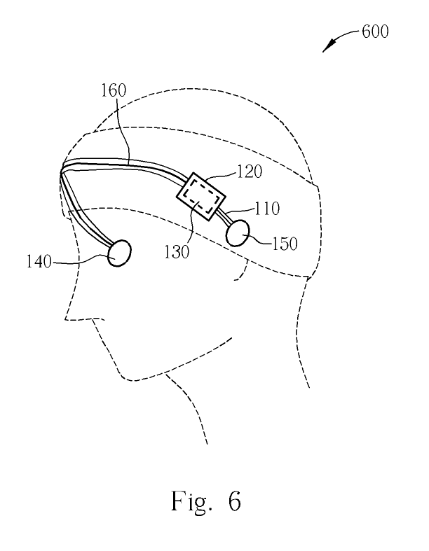

Please refer to FIG. 6. FIG. 6 is a diagram of a personal electronic audio device 600. A third embodiment of a personal electronic audio device 600 follows. According to a third embodiment of the present invention, the personal audio device 600 is integrated with a fleece headband. The functions of the various parts of the personal audio device 600 are identical to those of the first, second, and third embodiments so repeated details are omitted for brevity. In this embodiment of the present invention, the personal audio device 600 is connected to either the outer side or the inner side of the fleece headband utilizing any number of means for connecting such as Velcro fastening flaps. The pouch/soft pocket 120 and the audio device 130 can be located at any place along the circular headband. In this embodiment the pouch/soft pocket 120 and the audio device 130 are located toward the front and center of the headband with respect to the user's forehead as shown in FIG. 6. The audio devices 140, 150 are located snuggly inside the headband adjacent to the user's ears or can be easily located on the outer side of the headband still adjacent to the user's ears and can be easily fastened with any number of fastening means such as Velcro. The supporting conduit structure/soft structure 110, similar to the pouch/soft pocket 120 and the audio device 130, can be tucked snuggly inside the headband (i.e., along the inner side of the headband) or displayed on the outside of the headband (i.e., the outer side). Please note that for simplicity the storage media 135, shown in FIG. 1a is not shown in FIG. 6.

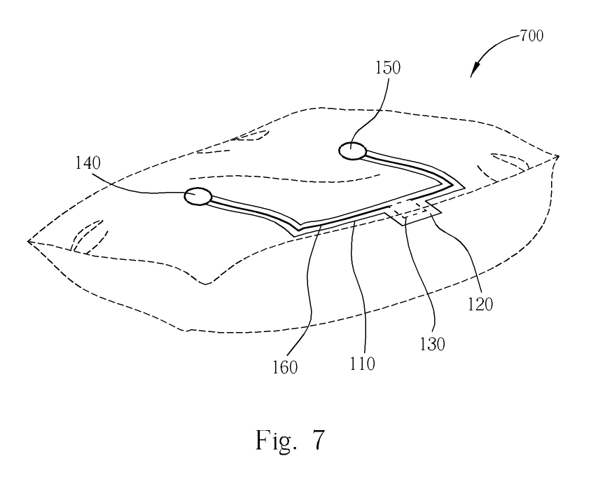

Please refer to FIG. 7. FIG. 7 is a diagram of a personal electronic audio device 700. A fourth embodiment of a personal electronic audio device 700 follows. According to a fourth embodiment of the present invention, the personal audio device 700 is integrated with a head pillow. The functions of the various parts of the personal audio device 700 are identical to those of the previous embodiments so repeated details are omitted for brevity. In this embodiment of the present invention, the personal audio device 700 is connected to the underside of the pillow utilizing any number of means for connecting such as Velcro fastening flaps. The pouch/soft pocket 120 and the personal audio device 130 can be located at any place along the supporting conduit structure/soft structure 110. The flexibility of the supporting conduit structure/soft structure 110 enables it to contour to the changing shape of the pillow therefore preventing the supporting conduit structure/soft structure 110 from being damaged (e.g., crushed, snapped, split, cracked). In this embodiment the pouch/soft pocket 120 and the personal audio device 130 are located on a side of the pillow proving the user with very easy access to the controls of the personal audio device 130. FIG. 7 shows the audio devices 140, 150 located and connected to the sides of the pillow and adjacent to the user's ears utilizing any number of means for connecting such as Velcro fastening flaps. Please note that for simplicity the storage media 135, shown in FIG. 1a is not shown in FIG. 7.

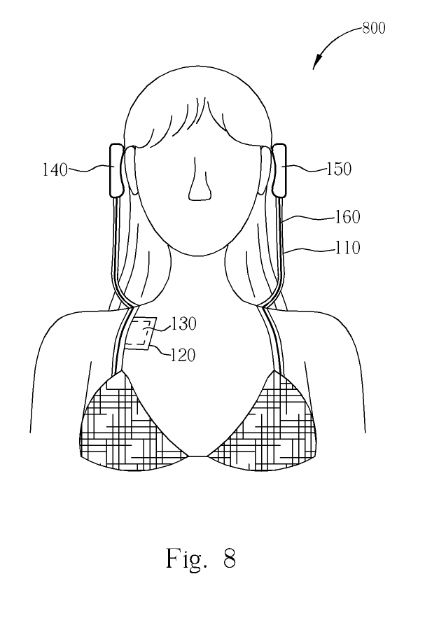

Please refer to FIG. 8. FIG. 8 is a diagram of a personal electronic audio device 800. A second embodiment of a personal electronic audio device 800 follows. According to a second embodiment of the present invention, the personal audio device 800 is integrated with an undergarment bra. The functions of the various parts of the personal audio device 800 are identical to those of the previous embodiments so repeated details are omitted for brevity. In this embodiment of the present invention, the pouch/soft pocket 120 is fastened to a strap area of the bra, for example, the section of the bra, as shown in FIG. 8, that couples the upper area of the bra cups and to the shoulder straps. In this embodiment, the flexibility of the supporting conduit structure/soft structure 110 can function as said bra shoulder straps. Alternatively, the supporting conduit structure/soft structure 110 can be fastened to existing bra shoulder straps making the personal electronic audio device 800 useful with existing bras. The audio devices 140, 150 extend from the supporting conduit structure/soft structure 110 at an upper most peak of the shoulder directly below the user's ears. Please note, there are many bra designs and bra strap designs, and only one example is provided in FIG. 8. However, one of average skill in the art can easily understand the many different ways that the supporting conduit structure/soft structure 110 can be integrated to either function as the straps or to piggyback onto existing straps. Please note that for simplicity the storage media 135, shown in FIG. 1a is not shown in FIG. 8.

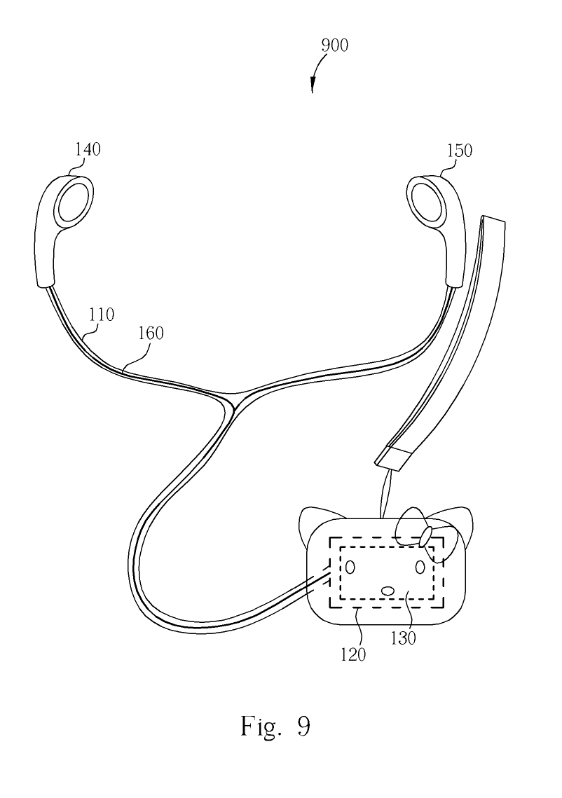

Please refer to FIG. 9. FIG. 9 is a diagram of a personal electronic audio device 900. A first embodiment of a personal electronic audio device 900 follows. According to a first embodiment of the present invention, the personal audio device 900 is integrated with a plush toy. The plush toy has an optional strap attached to it as shown in FIG. 9. The functions of the various parts of the personal audio device 900 are identical to those of the previous embodiments so repeated details are omitted for brevity. In this embodiment of the present invention, the pouch/soft pocket 120 is embedded within the plush toy, for example, a stuff animal toy. In this embodiment the user of the personal audio device 130 can have easy access to controls the personal audio device 130 via access holes, slots, or any number of other access openings (not shown in FIG. 9) that are well known to those skilled in this art. Additionally, controls of the personal audio device 130 can also be accessed through the plush toy (i.e., absent the access hole/slot, via any number of various elements, markers, or other indications on the external surface of the plush toy that indicate squeezing or pressing the plush toy in a particular location will result in controlling of the personal audio device 130. It is well known to those in this art that many ways are available to provide the user with very easy access to the controls of the personal audio device 130, either directly or indirectly (i.e., through) when integrated with a plush toy as shown in FIG. 9. Other methods are easily within the scope of the present invention. Please note that for simplicity the storage media 135, shown in FIG. 1a is not shown in FIG. 9.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A personal electronic audio device comprising:
a supporting conduit structure/soft structure for housing audio wires, the supporting conduit structure/soft structure comprising a pouch/soft pocket coupled thereon;
a first audio device, disposed in the pouch/soft pocket and coupled to the audio wires, for generating an audio signal; and
a second audio device, coupled to the audio wires, for receiving the audio signal and emitting a sound corresponding to the audio signal.

2. The personal electronic audio device of claim 1, wherein the first audio device comprises a mini stereo jack for transmitting data or conducting current to charge a battery contained within the first audio device.

3. The personal electronic audio device of claim 1, wherein the first audio device comprises a storage media.

4. The personal electronic audio device of claim 3, wherein the storage media is a semiconductor storage device, a magnetic storage device, or an optical storage device.

5. The personal electronic audio device of claim 1, wherein the first audio device is a communication device.

6. The personal electronic audio device of claim 1, wherein the supporting conduit structure/soft structure is a flexible material.

7. The personal electronic audio device of claim 6, wherein the flexible material is selected from the group consisting of leather, textile, rubber, and neoprene.

8. The personal electronic audio device of claim 1, wherein the pouch/soft pocket is a flexible material.

9. The personal electronic audio device of claim 8, wherein the flexible material is selected from the group consisting of textile, rubber, and neoprene.

10. The personal electronic audio device of claim 1, wherein the supporting conduit structure is of a horseshoe shape and the soft structure is of an asymmetric triangular shape.

11. The personal electronic audio device of claim 1, wherein the second audio device comprises a speaker for emitting the sound corresponding the audio signal.

12. The personal electronic audio device of claim 11, wherein the second audio device further comprises a microphone for converting a sound into an audio signal transmitted to the first audio device.

13. The personal electronic audio device of claim 11, wherein the speaker is an earphone.

14. The personal electronic audio device of claim 1, wherein the audio signal generated from the first audio device includes a first channel audio signal and a second channel audio signal, the second audio device is utilized for emitting a sound corresponding to the first channel audio signal, and the personal electronic audio device further comprises a third audio device, coupled to the audio wires, for receiving the second channel audio signal and emitting a sound corresponding to the second channel audio signal.

15. The personal electronic audio device of claim 14, wherein the second audio device comprises a speaker for emitting the sound corresponding to the first channel audio signal, and the third audio device comprises a speaker for emitting the sound corresponding to the second channel audio signal.

16. The personal electronic audio device of claim 15, wherein the speaker in each of the second and third audio devices is an earphone.
